(19) United States
(12) Patent Application Publication
(10) Pub. No.: US 2015/0292685 A1
(43) Pub. Date: Oct. 15, 2015

(54) Illumination Equipment for a Factory Building

(71) Applicant: SUNFLY SOLAR TECHNOLOGY CO., LTD., Tainan City (TW)

(72) Inventor: Sian-Tang Jheng, Tainan City (TW)

(73) Assignee: SUNFLY SOLAR TECHNOLOGY CO., LTD., Tainan City (TW)

(21) Appl. No.: 14/249,393

(22) Filed: Apr. 10, 2014

(51) Int. Cl. F21K 99/00; E04D 13/03; F21V 31/00; E04D 13/00

(52) U.S. Cl. CPC F21K 9/52; E04D 13/00; E04D 13/03; F21V 31/00; F21Y 2101/02

(57) ABSTRACT

Illumination equipment for a factory building contains: a light-pervious roofing, an LED washer, a waterproof cover, a light pipe, a diffuser and a base. The light-pervious roofing is locked with the waterproof cover which is fitted on the light pipe, the diffuser is mounted on the light pipe, the light pipe is inserted into the base and a building roof, and the base is secured on the building roof. Between the light-pervious roofing and the waterproof cover is defined the LED washer including an LED element, such that when light luminance in a factory building is not sufficient, the LED element is started by a power source to illuminate the factory building, the waterproof cover is fitted on the base, the waterproof cover and the base are adjusted so that their fitting angle is located in a horizontal level, and the waterproof cover is fixed on the base.

### FIELD OF THE INVENTION

The present invention relates to illumination equipment for a factory building which corresponds to an oblique angle of a building roof so as to adjust a light-pervious roofing and a light pipe to be located in a horizontal level.

### BACKGROUND OF THE INVENTION

As illustrated in FIGS. 1 and 2, conventional illumination equipment 1 for a factory building contains a light-pervious roofing 10, a connector 11, a retaining loop 12, a base 13, a light pipe 14 and a diffuser 15, wherein the light-pervious roofing 10 is fitted with the connector 11, and the light-pervious roofing 10 and a bottom end of the connector 11 are disposed on a central portion of the retaining loop 12, the retaining loop 12 is retained with the base 13 so that the light pipe 14 is inserted through a bottom end of the base 13 to lock with the base 13, thereafter the diffuser 15 is fixed on a bottom end of the light pipe 14, such that the illumination equipment 1 is assembled completely, and the base 13 of the illumination equipment 1 is mounted on a building roof.

Nevertheless, the illumination equipment has the following defects:

1. The light pipe is cylindrical and is made of aluminum material, and a PVD reflecting film is adhered in the light pipe, the light pipe is therefore oxidized and is damaged at a high temperature easily.

2. When the base is fixed on the building roof at an oblique angle after the illumination equipment is assembled completely, the light-pervious roofing and the light pipe are titled relative to the building roof, so they cannot be adjusted laterally to reduce light guiding effect.

The present invention has arisen to mitigate and/or obviate the afore-described disadvantages.

### SUMMARY OF THE INVENTION

The primary objective of the present invention is to provide illumination equipment for a factory building which corresponds to an oblique angle of a building roof so as to adjust a light-pervious roofing and a light pipe to be located in a horizontal level.

Further objective of the present invention is to provide illumination equipment for a factory building which when light luminance in a factory building is not sufficient, an LED element of an LED washer is started by a power source to illuminate the factory building.

Another objective of the present invention is to provide illumination equipment for a factory building in which related components of the illumination equipment are recyclable to comply with environmental standard and requirement.

### BRIEF DESCRIPTION OF THE DRAWINGS

FIG. 1 is a perspective view showing the assembly of conventional illumination equipment for a factory building.

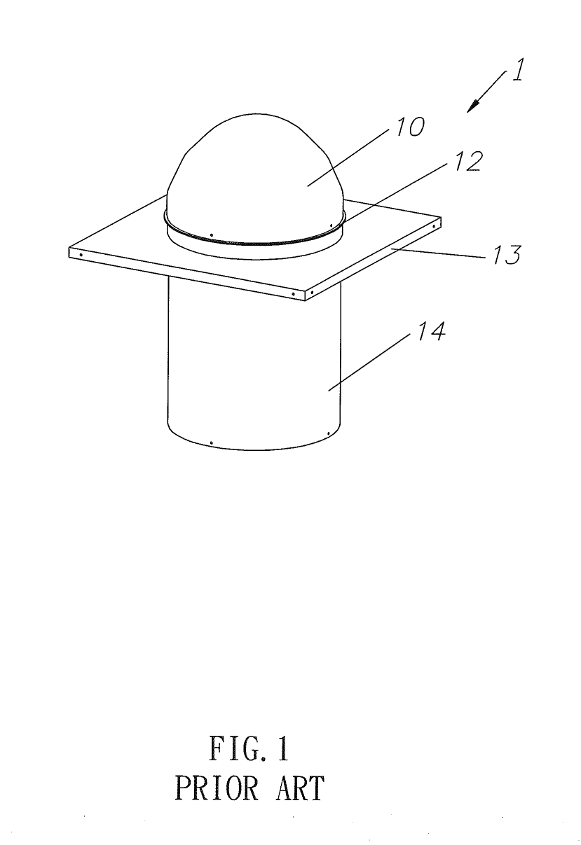

FIG. 2 is a perspective view showing the exploded components of the conventional illumination equipment for the factory building.

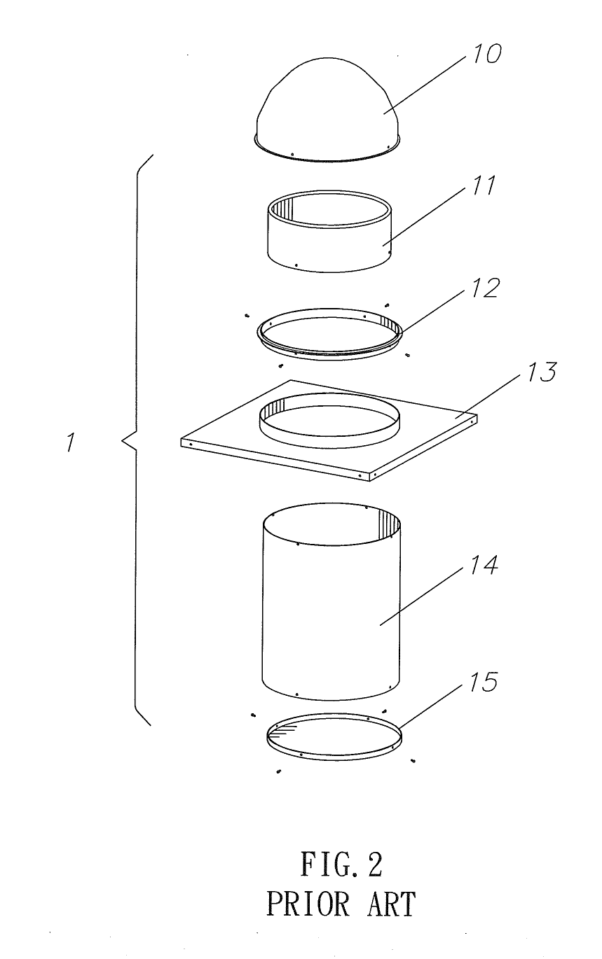

FIG. 3 is a perspective view showing the assembly of illumination equipment for a factory building according to a preferred embodiment of the present invention.

FIG. 4 is a perspective view showing the exploded components of the illumination equipment for the factory building according to the preferred embodiment of the present invention.

FIG. 5 is a cross sectional view showing the operation of the illumination equipment for the factory building according to the preferred embodiment of the present invention.

FIG. 6 is another cross sectional view showing the operation of the illumination equipment for the factory building according to the preferred embodiment of the present invention.

### DETAILED DESCRIPTION OF THE PREFERRED EMBODIMENTS

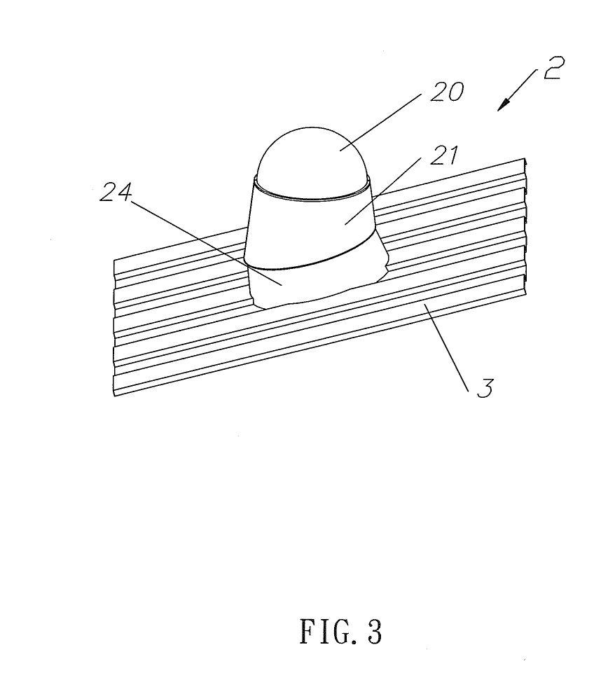

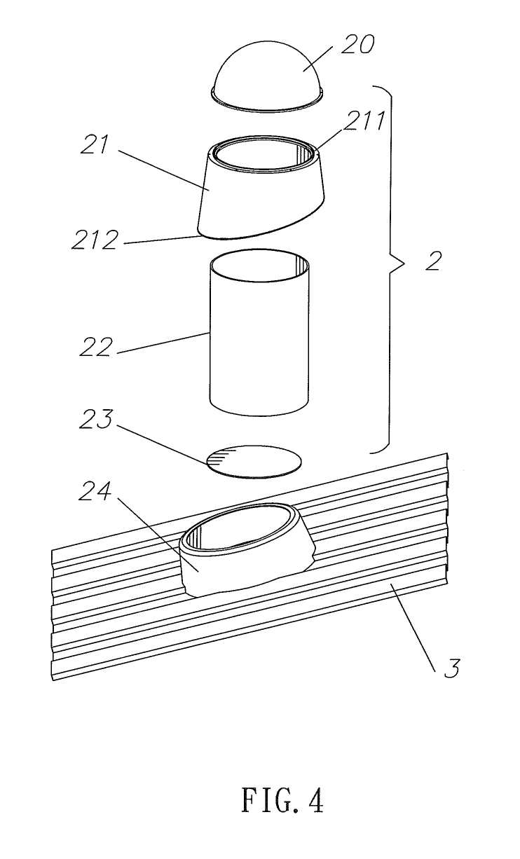

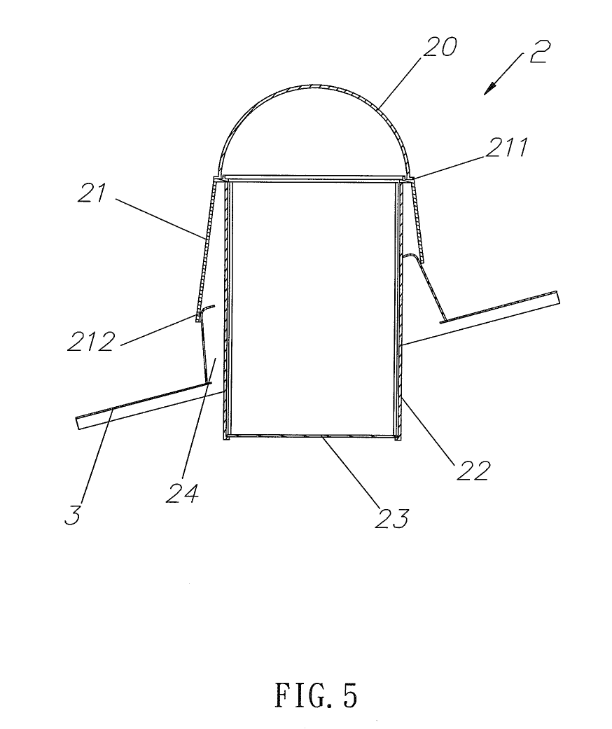

With reference to FIGS. 3 to 5, illumination equipment 2 for a factory building according to a preferred embodiment of the present invention comprises: a light-pervious roofing 20, an LED washer 25, a waterproof cover 21, a light pipe 22, a diffuser 23 and a base 24, wherein the light-pervious roofing 20 is added with UV stabilizer to isolate ultraviolet and to stop radiant heat entering a factory building. The waterproof cover 21 is made of stainless steel and is hollow, and the waterproof cover 21 includes a flat fringe 211 defined around a top end thereof and connecting with the light-pervious roofing 20. The waterproof cover 21 also includes a tiled fringe 212 formed around a bottom end thereof and fitted with the base 24 which is secured on a building roof 3. The light pipe 22 is PVD sputtered from reflective mirror material to guide lights. The diffuser 23 is made of flameproof PC material to diffuse light evenly. The LED washer 25 includes an LED element 250 arranged therein and is fixed on the top end of the waterproof cover 21, and a bottom end of the light-pervious roofing 20 is locked with the top end of the waterproof cover 21, the LED washer 25 is retained between the light-pervious roofing 20 and the waterproof cover 21 so that the waterproof cover 21 is fitted on the light pipe 22, and the diffuser 23 is mounted on a bottom end of the light pipe 22. A lower end of the light pipe 22 is inserted into the base 24 so that the waterproof cover 21 is adjustably fitted on the base 24, and the light pipe 22 and the light-pervious roofing 20 are adjusted to correspond to an oblique angle of the building roof 3 and then are adjusted to be located in a horizontal level, hence the waterproof cover 21 is aligned and connected with the base 24 matingly.

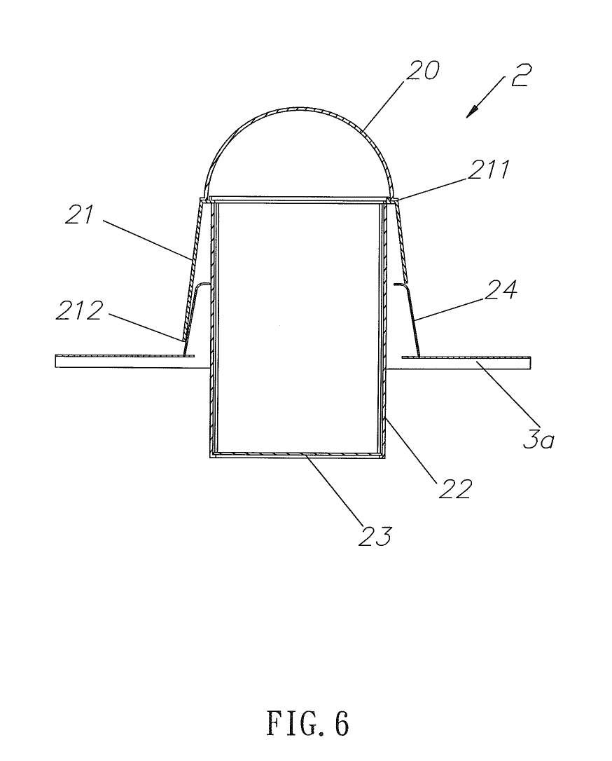

Referring to FIG. 6, as desiring to fix anther building roof 3a at another angle, the light pipe 22 is inserted into the base 24 and the building roof 3a so that the waterproof cover 21 is fitted on the base 24, and the waterproof cover 21 and the base 24 are adjusted so that their fitting angle is located in the horizontal level, thereafter the waterproof cover 21 is fixed on the base 24.

Accordingly, the illumination equipment of the present invention has advantages as follows:

1. The light-pervious roofing is added with the UV stabilizer to isolate ultraviolet and to stop the radiant heat entering the factory building.

2. The light pipe is PVD sputtered from reflective mirror material to guide light source to enter into the factory building, and the illumination equipment will not be damaged by the lights at a high temperature.

3. The diffuser is made of the flameproof PC material to diffuse light evenly.

It is to be noted that the light-pervious roofing, the waterproof cover, the light pipe and the diffuser are connected together, and then the waterproof cover is fitted on the base, thereafter the waterproof cover and the base are adjusted so that their fitting angle is located in the horizontal level, such that the waterproof cover and the base correspond to a water discharging angle of the factory building, thus obtaining excellent illumination.

Between the light-pervious roofing and the waterproof cover is defined the LED washer which includes the LED element, so the light source illumines into the factory building through the light-pervious roofing. Furthermore, when the light luminance in the factory building is not sufficient, the LED element of the LED washer is started by a power source to illuminate the factory building.

Related components of the illumination equipment are recyclable to comply with environmental standard and requirement.

While we have shown and described various embodiments in accordance with the present invention, it is clear to those skilled in the art that further embodiments may be made without departing from the scope of the present invention.

What is claimed is:

1. Illumination equipment for a factory building comprising: a light-pervious roofing, an LED washer, a waterproof cover, a light pipe, a diffuser and a base, wherein the light-pervious roofing is locked with a top end of the waterproof cover, the waterproof cover is fitted on the light pipe, the diffuser is mounted on a bottom end of the light pipe, the light pipe is inserted into the base and a building roof, and the base is secured on the building roof;
characterized in that between the light-pervious roofing and the waterproof cover is defined the LED washer which includes an LED element, such that when light luminance in a factory building is not sufficient, the LED element of the LED washer is started by a power source to illuminate the factory building, the waterproof cover is fitted on the base, and the waterproof cover and the base are adjusted so that their fitting angle is located in a horizontal level, and the waterproof cover is fixed on the base.
